(19) United States
(12) Patent Application Publication
(10) Pub. No.: US 2015/0048782 A1
(43) Pub. Date: Feb. 19, 2015

(54) Electric Power Supply Adapter Device for Club Car Golf Cars and Utility Vehicles

(71) Applicants: Trevor Jason Back, Indianapolis, IN (US); Tyler Jon Back, San Francisco, CA (US)

(72) Inventors: Trevor Jason Back, Indianapolis, IN (US); Tyler Jon Back, San Francisco, CA (US)

(21) Appl. No.: 13/969,548

(22) Filed: Aug. 17, 2013

(51) Int. Cl. H02J 7/00

(52) U.S. Cl. CPC H02J 7/0042; H02J 7/007
USPC 320/107

(57) ABSTRACT

An electric power supply adapter device that plugs into an IQ port of an electric golf car or electric utility vehicle used to power an electronic apparatus. The main components consist of input electric connectors positioned in the housing and adapted to fit an IQ port of an electric golf car or electric utility vehicle, a DC converter module to convert input power from the IQ port of an electric golf car or electric utility vehicle into the required DC output power, and an output electric connector adapted to receive an electronic apparatus and to transmit the DC output power from the DC converter module to the electronic apparatus.

### CROSS-REFERENCE TO RELATED APPLICATIONS

This application claims priority to U.S. Provisional Patent Application 61684788, filed, Aug. 19, 2012 which is incorporated by reference herein.

### REFERENCES CITED

Jun. 7, 2012, Holland, US 2012/0139335

### BACKGROUND OF THE INVENTION

1. Field of the Invention

The present invention is in the technical field of power supplies. More particularly, the present invention is in the technical field of adapting electric power from a power source that has relatively high voltage for use in charging an electronic apparatus that cannot use such voltage directly, but requires lower voltage and a specific current.

With the rising number of electronic apparatuses being used daily and their increased capabilities and therefore increased power demands, there are several adapters available for sourcing power to charge the batteries within an electronic apparatus over the course of a day. Unfortunately, for people in Club Car electric golf cars and electric utility vehicles, there is not yet such an adapter for tapping into the power supply of the electric golf car or electric utility vehicle through the vehicle's conveniently located IQ port. The IQ port is located on Club Car electric golf cars and electric utility vehicles, and is used to communicate with the Club Car IQ system or IQ Plus system. A device called the IQDM (IQ Display Module), is typically plugged into the IQ port. The IQDM is a hand held programming and diagnostic tool for use with Club Car IQ System vehicles

There is a growing number of golf applications for smart phones. For example, GPS (global positioning system) applications are available to help players navigate golf courses. Although the applications are very popular, many golfers are disappointed that their smart phones run out of power before they come to the end of their game at the golf course.

What is needed is a simple adapter to source the power found at the IQ port in a Club Car electric golf car and electric utility vehicle for use in charging electronic apparatuses.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 illustrates a top view of an electric power supply adapter device of the present invention;

FIG. 2 is a perspective view of an electric power supply adapter device of the present invention;

FIG. 3 is a connection diagram of an electric power supply adapter device of the present invention; and

FIG. 4 is a circuit block diagram of an electric power supply adapter device of the present invention.

### SUMMARY

The above and other objects, which will be apparent to those skilled in the art, are achieved in the present invention which is directed to a device for sourcing electrical power found at the IQ port of Club Car electric golf cars and electric utility vehicles for use by an electronic apparatus, comprising a first fitting designed to connect electrically to an IQ port of a Club Car electric golf car and electric utility vehicle.

The device also includes a DC converter module in electric communication with the first fitting, the DC converter module configured to convert input DC voltage and current to a usable output DC voltage and current.

The device further includes a second fitting in electrical communication with the DC converter module, wherein the second fitting is configured to make an electrical connection with an electronic apparatus.

### DETAILED DESCRIPTION

The preferred embodiments are illustrated in the context of sourcing power found at the IQ port in a Club Car electric golf car or electric utility vehicle. The skilled artisan will readily appreciate, however, that the materials and methods disclosed herein will have application in a number of other contexts where sourcing electric power found at the IQ port in a Club Car electric golf car or electric utility vehicle is desirable, particularly where no other convenient power source is available.

These and other objects and advantages of the present invention will become more fully apparent from the following description taken in conjunction with the accompanying drawings.

Reference will now be made to the drawings wherein like numerals refer to like parts throughout.

Definitions

The term, “electric utility vehicle,” is used to mean electric vehicles generally intended for off road use that have a top speed of less than about 40 mph. Examples include, but are not limited to electric golf cars, electric general utility vehicles such as used by ground services and maintenance departments, electric power mowers, electric lawn care equipment, and small electric tractors. The term, “electric golf car”, sometimes called, “electric golf carts,” is used to mean electric vehicles generally intended to have a top speed of less than 25 mph and carry golfers and their golf clubs. Specific examples of golf cars include, but are not limited to E-Z-GO™, Club Car™, and Yamaha™.

In one embodiment of the invention, an electric power supply adapter device plugs into an IQ port of a Club Car electric golf car or electric utility vehicle. According to one aspect of the present invention, the electric power supply adapter device includes input electric connectors adapted to fit an IQ port of a Club Car electric golf car or electric utility vehicle, a DC (direct current) converter module to convert input DC voltage and current from the IQ port of a Club Car electric golf car or electric utility vehicle into a desired output DC voltage and current, and an output electric connector adapted to connect to an electronic apparatus and to transmit the DC output power from the DC converter module to the electronic apparatus. Examples of such electronic apparatuses may include, but are not limited to, a mobile phone, smart phone, an iPhone™, an iPad™, a Blackberry™, an Android™, a SkyCaddie™, audio speakers, GPS units, a tablet, a fan, and a light.

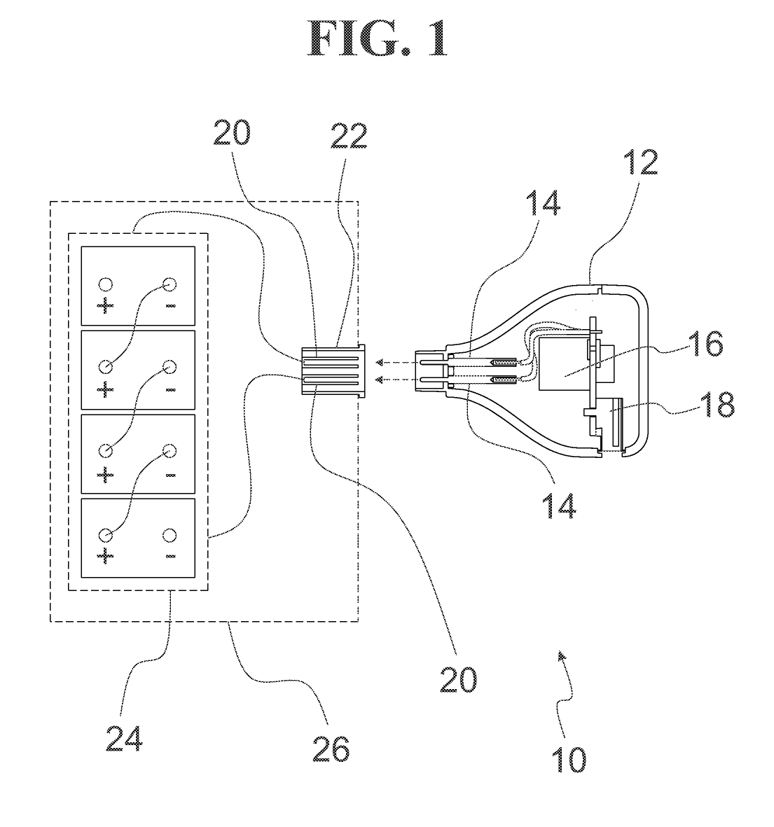

In one embodiment of the invention, as shown in FIG. 1 an electric power supply adapter device 10 is provided. There is a first fitting configured to fit an IQ port 22. There is a DC converter module 16 in electric communication with the first fitting. There is a second fitting in electric communication with the DC converter module 16. The first fitting may use, but is not limited to use, prongs, pins, or flexible conductive material to make an electric connection with the electric connectors 20 of the IQ port 22 of a Club Car electric golf car or electric utility vehicle 26. There is a housing 12, which may be made of plastic, rubber, or exotic materials to fit an individual IQ port 22, or may use a universal shape to fit a plurality of ports. The DC converter module 16 is electrically connected to an output electric connector 18, which may use, but is not limited to use, a USB (universal serial bus) port, multiple USB ports, a cable directly integrated and adapted to interface with the power port of an electronic apparatus, or other electrical connections.

In an exemplary embodiment, referring now to the invention in more detail, in FIG. 1 there is shown an electric power supply adapter device 10 which may have a multiple part housing 12 containing multiple input electric connectors 14, a DC converter module 16, and an output electric connector 18. Each of the input electric connectors 14 is in electric communication with the DC converter module 16 which is in electric communication with the output electric connector 18.

In further detail, still referring to the invention of FIG. 1, there is shown the inner cavity of the housing 12 which may contain the circuitry for obtaining power found at the IQ port 22 in a Club Car electric golf car or electric utility vehicle 26, converting the power to the required voltage and current, and transmitting the power to the electronic apparatus.

In further detail, still referring to the invention of FIG. 1, the housing 12 may be designed to align the input electric connectors 14 of the electric power supply adapter device 10 with the electric connectors 20 of the IQ port 22 of a Club Car electric golf car or electric utility vehicle 26. The electric connectors 20 of the IQ port 22 of a Club Car electric golf car or electric utility vehicle 26 electrically connect with a battery supply 24 in the Club Car electric golf car or electric utility vehicle 26. The input electric connectors 14 of the electric power supply adapter device 10 may have a shape, size, length, and distance between them which allow them to operationally engage with the electric connectors 20 of the IQ port 22 of a Club Car electric golf car or electric utility vehicle 26.

The shapes, dimensions, materials of construction, and arrangements of the parts of the various embodiments of the invention as shown in FIG. 1 are not critical except as otherwise noted, and any shapes, dimensions, materials of construction, and arrangements of the parts may be used provided they allow those embodiments to operate and the benefits of this invention to be achieved.

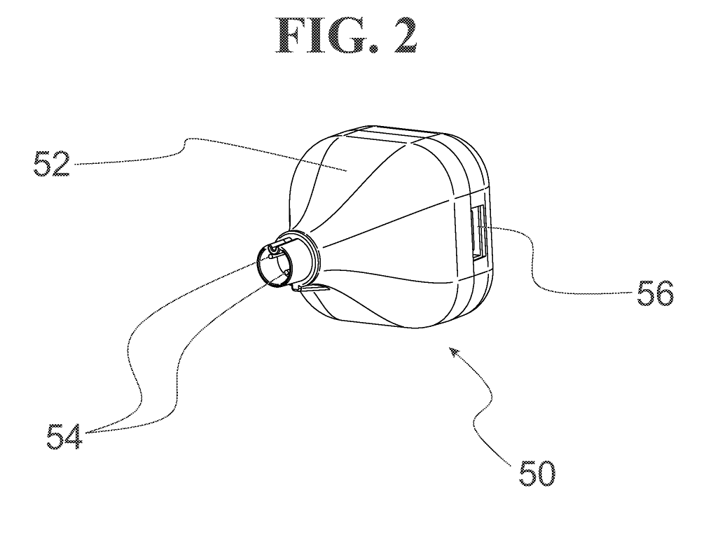

Referring now to the invention in more detail, FIG. 2 shows the same invention in FIG. 1. This view shows a possible configuration of an electric power supply adapter device 50 with the complete housing 52, the multiple input electric connectors 54, and the output electric connector 56.

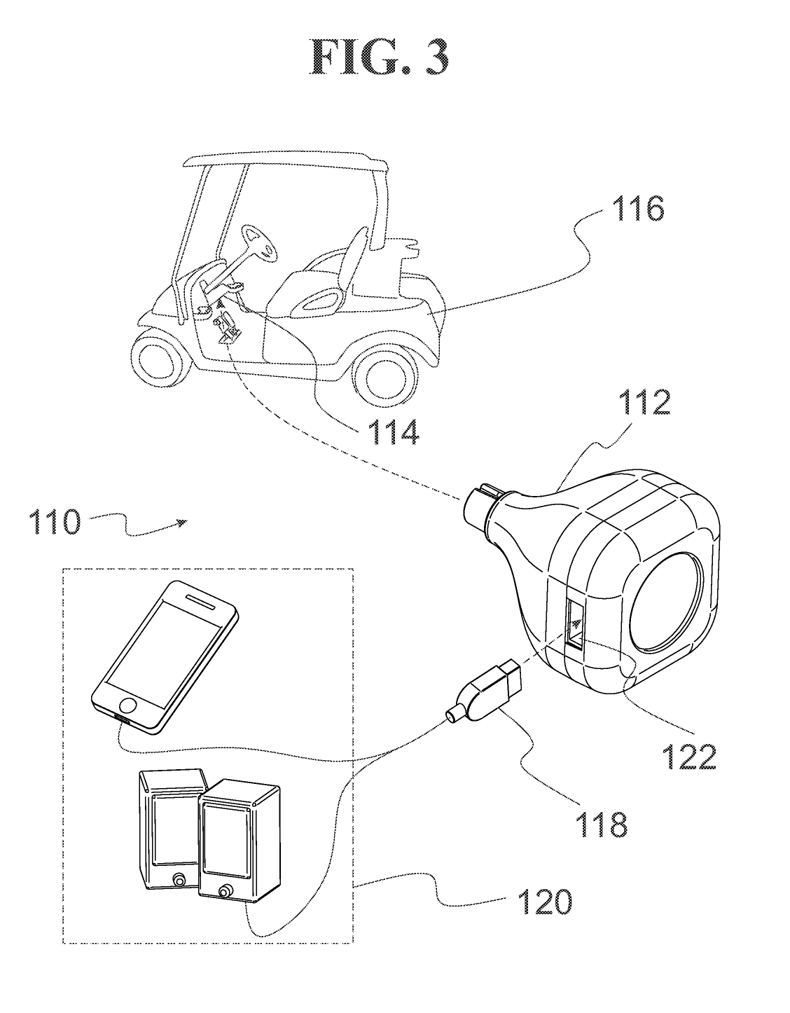

Referring now to the invention in more detail, in FIG. 3 there is shown what may be the intended connection diagram 110, which may have an electric power supply adapter device 112, a Club Car electric golf car or electric utility vehicle 116, an IQ port 114, a connector cable 118, and an electronic apparatus 120.

In further detail, still referring to the invention of FIG. 3 the electric power supply adapter device 112 may be plugged into the IQ port 114 of a Club Car electric golf car or electric utility vehicle 116. The electronic apparatus 120 may be connected to the output connector 122 of the electric power supply adapter device 112, and may be done through means of a connector cable 118. Thus, the power found at the IQ port 114 of a Club Car electric golf car or electric utility vehicle 116 provides power to the electronic apparatus 120.

In further detail, still referring to the invention of FIG. 3 the electric power supply adapter device 112 may be positionable in the IQ port 114 of a Club Car electric golf car or electric utility vehicle 116 such that the electric power supply adapter device 112 may operationally engage the electric connectors within the IQ port 114. The connector cable 118 may have one end connected to the output connector 122 of the electric power supply adapter device 112 and may have the other end terminating in an electric connector, connectable to a power port of an electronic apparatus 120.

The shapes, dimensions, materials of construction, arrangements of the parts, etc. of the various embodiments of the invention as shown in FIG. 3 are not critical except as otherwise noted, and any shapes, dimensions, materials of construction, arrangements of the parts, etc. may be used provided they allow those embodiments to operate and the benefits of this invention to be achieved.

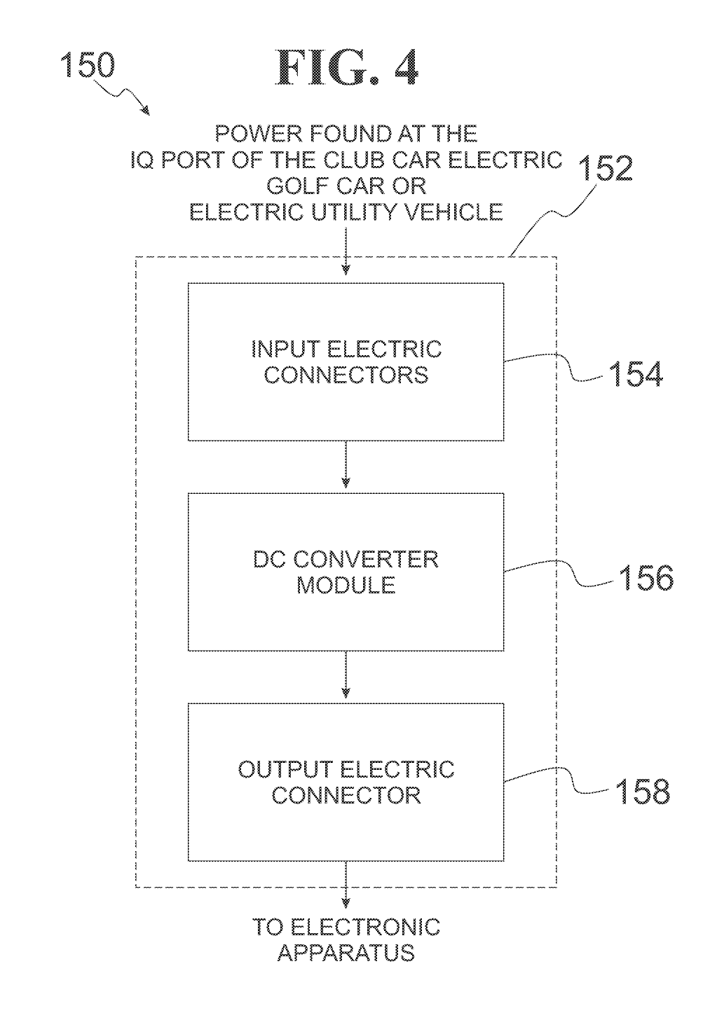

Referring now to the invention in more detail, in FIG. 4 there is shown a circuit block diagram 150 for showing an electric power supply adapter device 152, according to the present embodiment. The electric power supply adapter device 152 may contain within the housing multiple input electric connectors 154, a DC converter module 156, and an output electric connector 158.

The advantages of the present invention include, without limitation, the ability to allow an electronic apparatus to be powered conveniently from an IQ port of a Club Car electric golf car or electric utility vehicle. Club Car electric golf cars and electric utility vehicles have IQ ports that have a shape, electrical connector position, and DC voltage combination unlike any other type of port. The present invention conveniently fits into an IQ port of a Club Car electric golf car or electric utility vehicle, converts the input voltage and current to the required output voltage and current, and outputs the needed power to an electronic apparatus.

In broad embodiment, power found at the IQ port of a Club Car electric golf car or electric utility vehicle flows through the electric power supply adapter device and to the electronic apparatus.

The exemplary embodiment shown and discussed in FIGS. 1-4 is meant to be illustrative only and is not intended to be limiting in any way.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, methods, and examples, but by all embodiments and methods within the scope and spirit of the invention as claimed.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A device for sourcing electrical power found at the IQ port of a Club Car electric utility vehicle for use by an electronic apparatus, comprising:
a first fitting designed to connect electrically to an IQ port of a Club Car electric utility vehicle;
a DC converter module in electric communication with the first fitting, the DC converter module configured to convert input DC voltage and current to a usable output DC voltage and current; and
a second fitting in electrical communication with the DC converter module, wherein the second fitting is configured to make an electrical connection with an electronic apparatus.

2. The device of claim 1 wherein the first fitting is a universal design to fit multiple ports of electric utility vehicles.

3. The device of claim 1 wherein the electric utility vehicle comprises a Club Car electric golf car.

4. The device of claim 1 wherein the input voltage is between about 5 and 50 volts.

5. The device of claim 1 wherein the input voltage is between about 8 and 15 volts.

6. The device of claim 1 wherein the input current is between about 50 and 800 milliamps.

7. The device of claim 1 wherein the input current is between about 320 and 380 milliamps.

8. The device of claim 1 wherein the output voltage is between about 2 and 10 volts DC.

9. The device of claim 1 wherein the output voltage is between about 4.5 and 5.5 volts DC.

10. The device of claim 1 wherein the output current is between about 0.2 and 2.0 amps.

11. The device of claim 1 wherein the output current is between about 0.3 and 1.0 amps.

12. The device of claim 1 wherein the second fitting comprises a standard USB port.

13. The device of claim 1 wherein the second fitting comprises two standard USB ports.

14. The device of claim 1 wherein the second fitting comprises an integrated cable adapted to interface with an electronic apparatus.
